(19) United States
(12) Patent Application Publication
(10) Pub. No.: US 2003/0221107 A1
(43) Pub. Date: Nov. 27, 2003

(54) Method and apparatus for generating serial number

(75) Inventor: Chun-Un Kang, Seoul (KR)

Correspondence Address: SUGHRUE MION, PLLC, 2100 PENNSYLVANIA AVENUE, N.W., WASHINGTON, DC, 20037, US

(73) Assignee: SAMSUNG ELECTRONICS CO., LTD.

(21) Appl. No.: 10/373,708

(22) Filed: Feb. 27, 2003

(30) Foreign Application Priority Data
May 25, 2002 (KR) 2002-29118

(51) Int. Cl. H04L 9/00

(52) U.S. Cl. 713/176

(57) ABSTRACT

Provided are a method and an apparatus for generating a serial number which is granted to a predetermined product such as software. In the method, basic identification code data including data on a current date or random numbers are generated, and identification code data is generated using the basic identification code data. Rule data on conditions of the use of the product are set. MAC data is generated by substituting the identification code data and the rule data into a HASH function. The identification code data, the rule data, and the MAC data are coded using a predetermined encryption key to generate the serial number. Accordingly, a serial number can be created having the predetermined period of validity or authorisation to use a product for only authenticated users. Thus, several functions can be recognized using the serial number.

### BACKGROUND OF THE INVENTION

This application claims the priority of Korean Patent Application No. 2002-29118 filed on May 25, 2002 in the Korean Intellectual Property Office, the disclosure of which is incorporated herein in its entirety by reference.

1. Field of the Invention

The present invention relates to a method and an apparatus for generating a serial number which is granted to a predetermined product such as software, and more particularly, to a method and an apparatus for generating a serial number which cannot be counterfeited or forged.

2. Description of the Related Art

A serial number consists of numbers that are sequentially granted to a predetermined product (e.g., software) when being manufactured to post-manage customers. Thus, the serial number is provided along with a packaged product in the manufacturing process. In a conventional method used to prevent a serial number which has been sequentially/randomly made, from being counterfeited or forged, parity check bits are inserted in the serial number to verify the validity of the serial number. Thus, when using the conventional method, the parity check bits can be checked to verify the validity of a serial number presented by a user.

A serial number, which has parity check bits, that is generated using the conventional method may be protected by checking the parity check bits. However, a serial number system can be cracked within a short period of time using a genetic algorithm or a neural network frequently used in hacking. In this case, the serial number may be manipulated to create a plurality of illegal reproductions.

### SUMMARY OF THE INVENTION

Accordingly, the present invention provides a method and an apparatus for generating a serial number into which an existing serial number, rule data defined by a user, and various encryption algorithms are integrated, and a data structure of the serial number.

According to an aspect of the present invention, there is provided a method of generating a serial number used to identify a predetermined product. Basic identification code data including data on a current date or random numbers is generated, and identification code data is generated using the basic identification code data. Rule data on conditions of the use of the product is set. Message Authentication Code (MAC) data is generated by substituting the identification code data and the rule data into a HASH function. The identification code data, the rule data, and the MAC data are coded using a predetermined encryption key to generate the serial number.

Here, the rule data includes data on a user allowed to use the product, data on the period of validity of the product, or data on the number of times the product is used.

According to another aspect of the present invention, there is also provided an apparatus for generating a serial number used to identify a predetermined product. The apparatus includes an identification code generator, a rule data setter, a MAC data generator, and an encryptor. The identification code generator generates basic identification code data including data on a current date or random numbers, and generates identification code data using the basic identification code data. The rule data setter sets rule data on conditions of the use of the product. The MAC data generator generates MAC data by substituting the identification code data and the rule data for a HASH function. The encryptor encrypts the identification code data, the rule data, and the MAC data using a predetermined encryption key to generate the serial number.

According to still another aspect of the present invention, there is also provided a computer-readable recording medium on which a data structure of a serial number used to identify a predetermined product is recorded. The data structure includes an identification code, rule data, and MAC data. The identification code is generated based on data on a current date or random numbers. The rule data is data on conditions of the use of the product corresponding to the serial number. The MAC data is generated by substituting the identification code and the rule data into a HASH function.

The conditions include data on a user allowed to use the product or data on the period of validity of the product.

### BRIEF DESCRIPTION OF THE DRAWINGS

The above features and advantages of the present invention will become more apparent by describing in detail exemplary embodiments thereof with reference to the attached drawings in which:

FIG. 1 is a view of a data structure of a serial number according to the present invention;

FIG. 2 is a flowchart explaining a method of generating a serial number according to the present invention;

FIG. 3 is a block diagram of an apparatus for generating a serial number according to the present invention;

FIG. 4 is a picture illustrating a method of distributing a serial number with a predetermined product and then authenticating the serial number; and

FIG. 5 is a picture illustrating a method of distributing a predetermined product and authenticating a serial number when providing the predetermined product to a user.

### DETAILED DESCRIPTION OF THE INVENTION

Hereinafter, predetermined embodiments of the present invention will be described in detail with reference to the attached drawings.

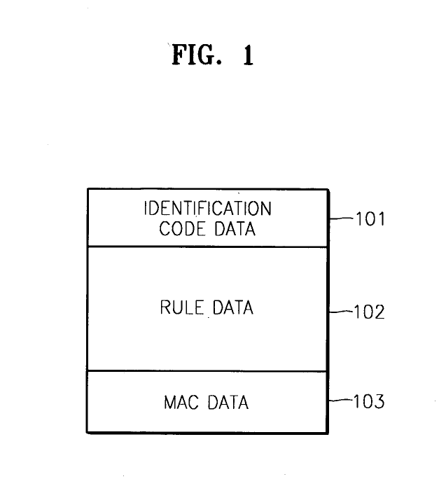

FIG. 1 shows a data structure of a serial number according to the present invention. The data structure of the serial number is granted to a predetermined product and includes identification (ID) code data 101, rule data 102, and MAC data 103.

The ID code data 101 refers to ID codes of products which may be generated based on a current date, or time, or random numbers.

The rule data 102 is generated based on data on a user allowed to use a product (i.e., an ID code such as the name, office name, and resident registration number of the user), data on the period of validity of the product (e.g., from Jan. 1, 2002 to Mar. 31, 2002), in a case where the product is software, data on how many times the software is installed in a predetermined computer, a usable system, data on installation environments, or restriction or allowance conditions related to the product.

The MAC data 103 is generated by substituting the ID code data 101 and the rule data 102 into a predetermined HASH function. For example, the HASH function may be a Secure HASH function. In this case, the MAC data 103 is generated by equation 1 below.

MAC=SHASH (ID code data, rule data) (1)

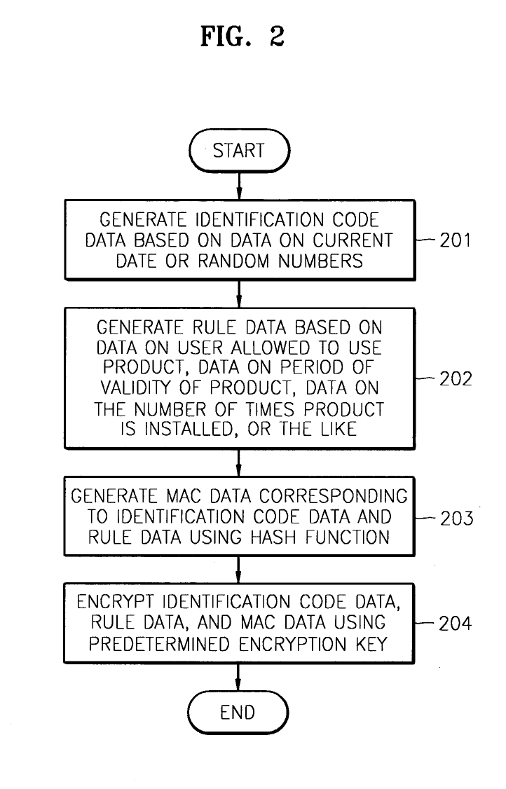

FIG. 2 is a flowchart explaining a method for generating a serial number according to the present invention.

In step 201, ID code data is generated based on data on a current date or random numbers. In step 202, rule data is generated based on data on a user allowed to use the product, data on the period of validity of the product, or the like. In step 203, MAC data corresponding to the ID code data and the rule data is generated using a predetermined HASH function. In step 204, the ID code data, the rule data, and the MAC data are coded using a predetermined encryption key to generate the serial number according to the present invention.

The predetermined encryption key may be a public key of a manufacturer, a public key of a product, a public key of a user, a super key, or the like. An algorithm used in coding may be a symmetrical algorithm (e.g., Double Encryption Standard (DES), 3DES, or advanced encryption standard (AES)) or an asymmetrical algorithm (e.g., Rivest-Shamir-Adelman (RSA), Elliptic Curve Cryptography (ECC), or the like). The algorithm used in coding is not limited.

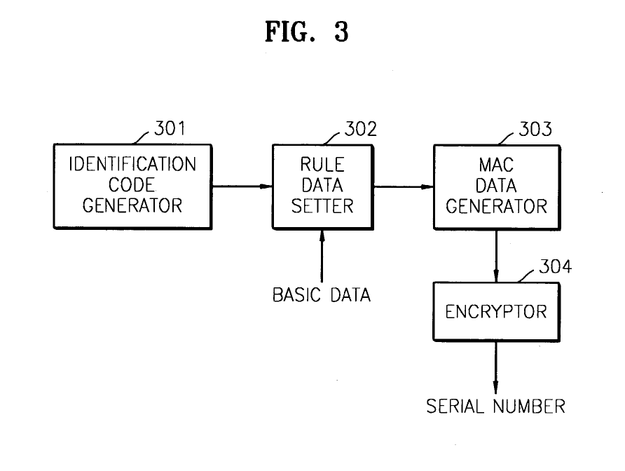

FIG. 3 is a block diagram of an apparatus for generating a serial number according to the present invention.

An ID code generator 301 generates ID code data based on current date data or random numbers data.

A rule data setter 302 receives basic data such as data on a user allowed to use a product, data on the period of validity of the product, or the like from the user and generates rule data based on received data.

A MAC data generator 303 receives the ID code data from the ID code generator 301 and the rule data from the rule data generator 302 and generates MAC data corresponding to the ID code data and the rule data using a predetermined HASH function.

An encryptor 304 encrypts the ID code data, the rule data, and the MAC data using a predetermined encryption key and generates a serial number according to the present invention.

The predetermined encryption key may be a public key of a manufacturer, a public key of a product, a public key of a user, a super key, or the like. An algorithm used in coding may be a symmetrical algorithm (e.g., DES, 3DES, or AES), or an asymmetrical algorithm (e.g., RSA, ECC, or the like). The algorithm used in coding is not limited.

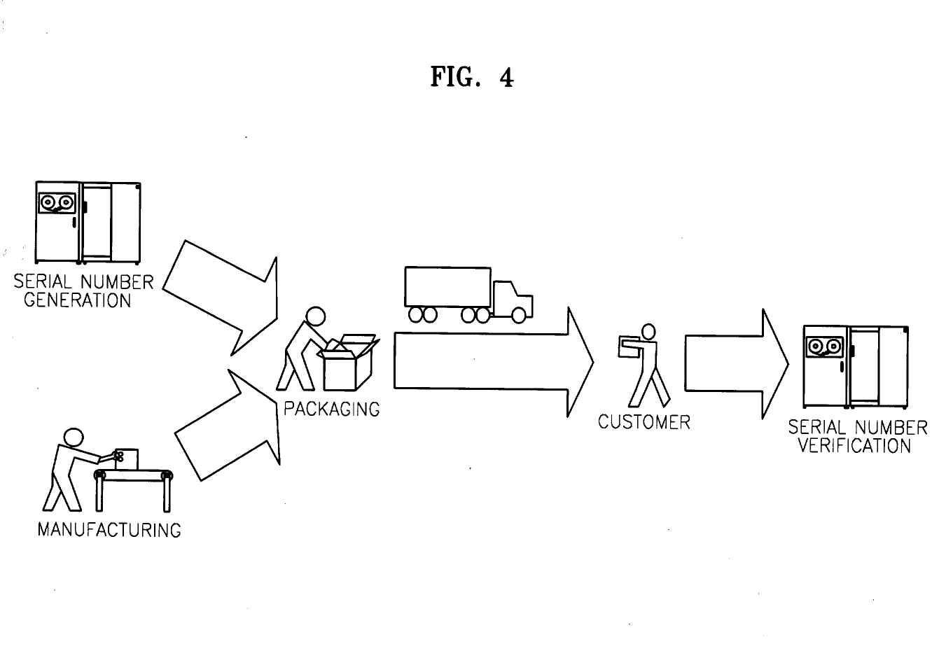

FIG. 4 illustrates a method of distributing a serial number according to the present invention with a predetermined product and then authenticating the serial number.

A serial number according to the present invention is created when manufacturing a product (software in FIG. 4), packaged with the product, and delivered to a user. The serial number is authenticated when installing and using the software.

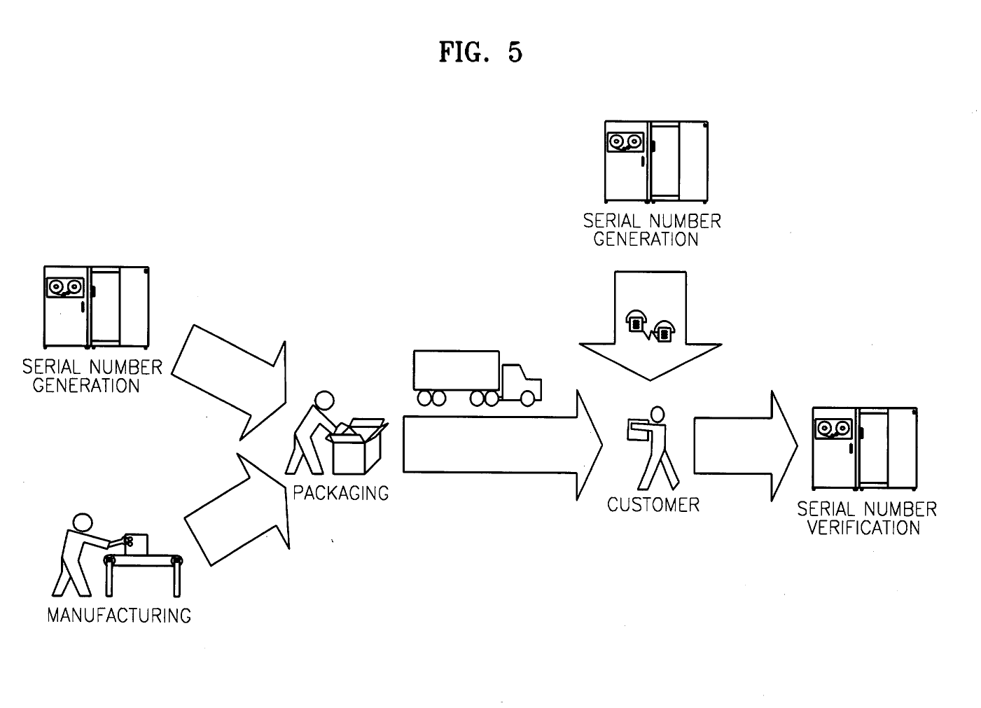

FIG. 5 illustrates a method of distributing a predetermined product and authenticating a serial number when providing the product to a user.

A predetermined product (software in FIG. 5) is manufactured, packaged, and delivered to a user. Next, when the user requests the issuing of a serial number via a communication network, the serial number is generated. The serial number is transmitted to the user via the communication network and authenticated when the user installs or uses the software in his or her computer.

According to the present invention, the following effects can be achieved.

First, a serial number having the predetermined period of validity can be created. For example, when publicity software is distributed, a serial number, which is valid only for 5 minutes, can be used.

Second, only authenticated users can use a product. In other words, a serial number is generated, including data on a user. Thus, the illegal reproduction and distribution of the serial number can be easily disclosed.

Third, a serial number according to the present invention cannot be manipulated.

Fourth, a product (software) granted the serial number according to the present invention is sold, and then the serial number is granted to a user when the user uses the product.

The above-described embodiments of the present invention can be drawn up as a program which can be executed in a computer. A general-purpose computer can recognize the program using a computer-readable recording medium.

The data structure described in an embodiment of the present invention can be recorded in a computer-readable recording medium using a plurality of units.

The computer-readable recording medium may include a magnetic storage medium (e.g., a ROM, a floppy disc, a hard disc, or the like), an optical reading medium (e.g., a CD-ROM, a DVD, or the like), and a carrier wave (e.g., the transmission over the Internet).

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method of generating a serial number used to identify a predetermined product, the method comprising:
(a) generating basic identification code data including data on a current date or random numbers, and generating identification code data using the basic identification code data;
(b) setting rule data on conditions of the use of the product;
(c) generating Message Authentication Code (MAC) data by substituting the identification code data and the rule data into a HASH function; and
(d) coding the identification code data, the rule data, and the MAC data using a predetermined encryption key to generate the serial number.

2. The method of claim 1, wherein in step (b), the rule data comprises data on a user allowed to use the product, data on the period of validity of the product, or data on the number of times the product is used.

3. An apparatus for generating a serial number used to identify a predetermined product, the apparatus comprising:
an identification code generator which generates basic identification code data including data on a current date or random numbers, and generates identification code data using the basic identification code data;
a rule data setter which sets rule data on conditions of the use of the product;
a Message Authentication Code (MAC) data generator which generates MAC data by substituting the identification code data and the rule data into a HASH function; and
an encryptor which encrypts the identification code data, the rule data, and the MAC data using a predetermined encryption key to generate the serial number.

4. A computer-readable recording medium on which a program for executing the method of claim 1 in a computer is recorded.

5. A computer-readable recording medium on which a program for executing the method of claim 2 in a computer is recorded.

6. A computer-readable recording medium on which a data structure of a serial number used to identify a predetermined product is recorded, the data structure comprising:
an identification code which is generated based on data on a current date or random numbers;
rule data which is data on conditions of the use of the product corresponding to the serial number; and
Message Authentication Code (MAC) data which is generated by substituting the identification code and the rule data into a HASH function.

7. The computer-readable recording medium of claim 6, wherein the conditions comprise data on a user allowed to use the product or data on the period of validity of the product.
